(19) United States
(12) Patent Application Publication
(10) Pub. No.: US 2005/0140798 A1
(43) Pub. Date: Jun. 30, 2005

(54) Digital still camera

(75) Inventors: Kei Tashiro, Ome-shi (JP); Tatsuhiko Ikehata, Ome-shi (JP); Shiro Nagaoka, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 10/986,794

(22) Filed: Nov. 15, 2004

(30) Foreign Application Priority Data
Dec. 25, 2003 (JP) 2003-428508

(51) Int. Cl. H04N 5/91

(52) U.S. Cl. 348/231.99

(57) ABSTRACT

When a shutter button for starting motion video imaging is pressed, a CPU of a digital still camera provides a header at a recording start position in a memory medium, thereby writing a motion video recording start position. Thus, the CPU starts writing motion video data. When a pause button is pressed, the CPU pauses the operation of recording in the memory medium. When the pause button is pressed once again, the write of motion video data in the memory medium is resumed. When the shutter button is pressed once again, the write of motion video data in the memory medium is finished. The CPU writes a motion video recording end position at the header in the memory medium and creates a single file of the imaged motion video. Thus, the CPU completes the imaging process.

### CROSS-REFERENCE TO RELATED APPLICATIONS

This application is based upon and claims the benefit of priority from prior Japanese Patent Application No. 2003-428508, filed Dec. 25, 2003, the entire contents of which are incorporated herein by reference.

### BACKGROUND OF THE INVENTION

1. Field of the Invention

The present invention relates to a digital still camera capable of taking a still image and motion video.

2. Description of the Related Art

There have been an increasing number of digital still cameras in the prior art, which can take not only still images but also motion video (e.g. Jpn. Pat. Appln. KOKAI Publication No. 2002-142145).

In the case of taking motion video with a digital still camera, the acquired motion video is stored in a recording medium as one file (one clip). A maximum possible imaging time of one clip is several seconds to several minutes, although it varies depending on the capacity of a built-in memory or a recording medium.

In the prior-art, if the time duration of a scene to be imaged exceeds the maximum possible imaging time of one clip, or if an unnecessary scene intervenes in the scene to be imaged, a number of imaging operations are executed to image only necessary parts of the scene. For example, if there are two unnecessary scenes in the entire scene, three imaging operations are executed repeatedly. As a result, three files are created in the recording medium.

The three files, however, are independent from each other and unrelated. It is difficult to reproduce them in succession. Moreover, if the number of such files increases, it is also difficult to manage them.

In order to put a plurality of files together into a single file, it is necessary to perform an editing work after imaging, using a personal computer or some other editing device.

On the other hand, in the case of a camcorder that uses a magnetic tape as a recording medium, there is no concept of “file.” Scenes that are recorded on a magnetic tape are successively reproduced. Thus, the above-mentioned problem does not arise.

As has been described above, when motion video is taken, a file is created each time the imaging operation is stopped. In reproducing motion video, it is thus necessary to select a file and it is difficult to continuously reproduce a long-time scene.

### BRIEF SUMMARY OF THE INVENTION

The object of an aspect of the present invention is to provide a digital still camera that is capable of imaging, at a time of motion video imaging, only necessary parts in a long-time scene as a single file.

According to an aspect of the present invention, there is provided a digital still camera including imaging means for taking a still image and motion video, display means for displaying still image data and motion video data that is taken by the imaging means, and recording means for recording the still image data and motion video data that is taken by the imaging means, the digital still camera comprising: pause instruction means for instructing a pause of imaging during the imaging of the motion video; first control means for executing a control to effect a pause of the recording of the motion video data in the recording means when the pause of the imaging is instructed by the pause instruction means; resume instruction means for instructing resumption of the recording of motion video data in the recording means, which is paused by the control of the first control means; second control means for executing a control to resume the recording of motion video data in the recording means when the resumption of the recording is instructed by the resume instruction means; stop instruction means for instructing a stop of the imaging of the motion video; and third control means for executing, when the stop of the imaging of the motion video is instructed by the stop instruction means, a control to put together the motion video data recorded in the recording means, which includes motion video data taken before and after the pause, into a single file, and to store the single file in the recording means.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 shows an external structure of the rear side of a digital still camera to which an embodiment of the present invention is applicable;

FIG. 2 is a block diagram that schematically shows the structure of a control system of the digital still camera;

FIG. 3 shows an example of recording in the case where motion video is imaged with a prior-art digital still camera;

FIG. 4 shows a configuration of files created in association with a recording time in the prior art;

FIG. 5 is a flow chart illustrating a motion video imaging operation in the digital still camera according to the present invention;

FIG. 6 is a view for explaining a recording time and a configuration of created files;

FIG. 7 shows a file configuration to which indices are added;

FIG. 8 shows an example of a screen for selecting an index at a time of reproduction;

FIG. 9 shows a file configuration to which special effects are added;

FIG. 10 shows an example of display at the time of motion video imaging in the digital still camera according to the invention;

FIG. 11 shows an example of display at the time of motion video imaging in the digital still camera according to the invention; and

FIG. 12 shows an example of display at the time of motion video imaging in the digital still camera according to the invention.

### DETAILED DESCRIPTION OF THE INVENTION

An embodiment of the present invention will now be described with reference to the accompanying drawings.

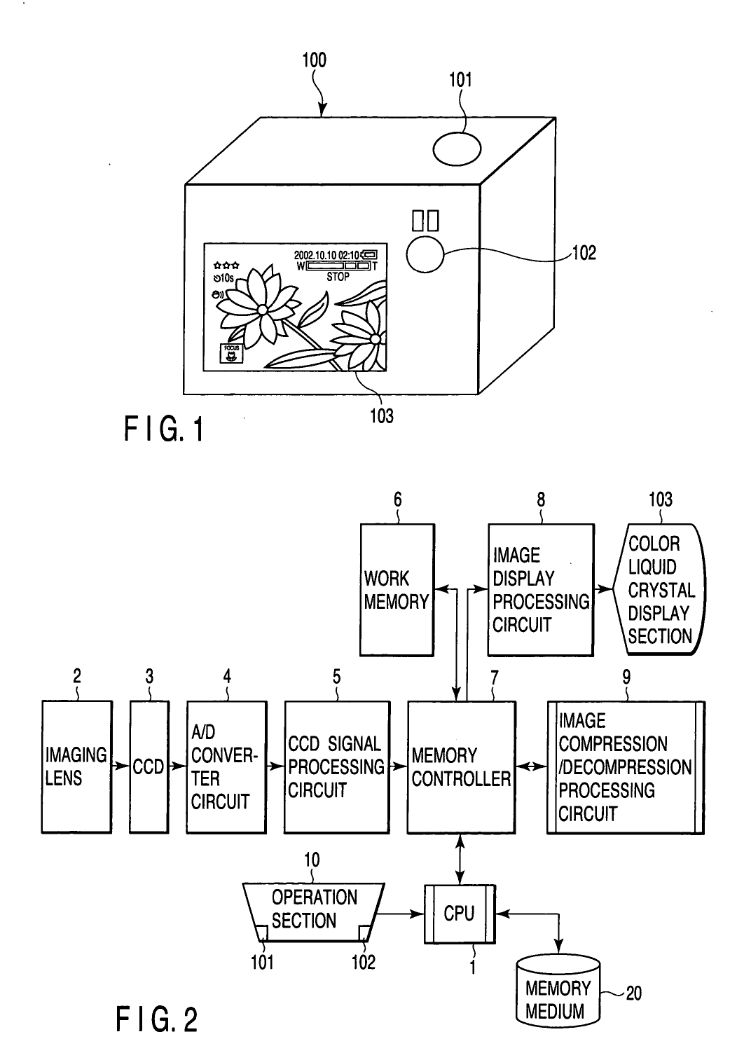

FIG. 1 shows an external structure of the rear side of a digital still camera according to the present invention. A camera body 100 is provided with a shutter button 101, a pause button 102 and a color liquid crystal display section 103.

FIG. 2 schematically shows the structure of a control system of the digital still camera shown in FIG. 1. Specifically, the digital still camera comprises a CPU 1 for an overall control; an imaging lens 2; a CCD (Charge-Coupled Device) 3; an A/D converter circuit 4 for converting an analog signal to a digital signal; a CCD signal processing circuit 5 for processing a digital signal; a work memory 6 for temporarily storing a process signal, etc.; a memory controller 7 for controlling the work memory 6, etc.; a color liquid crystal display section 103 that displays an image delivered from an image display processing circuit 8; and an image compression/decompression processing circuit 9 that performs a compression/decompression process for a digital signal.

The CPU 1 is connected to an operation section 10 and a memory medium 20 such as a memory card.

The operation section 10 is provided with operation buttons including the shutter button 101 and pause button 102, and executes various operations.

The memory medium 20 is configured to be attachable/detachable. A video signal (compressed digital signal) is transferred and recorded in the memory medium 20.

In order to describe the present invention, a prior-art system is first described.

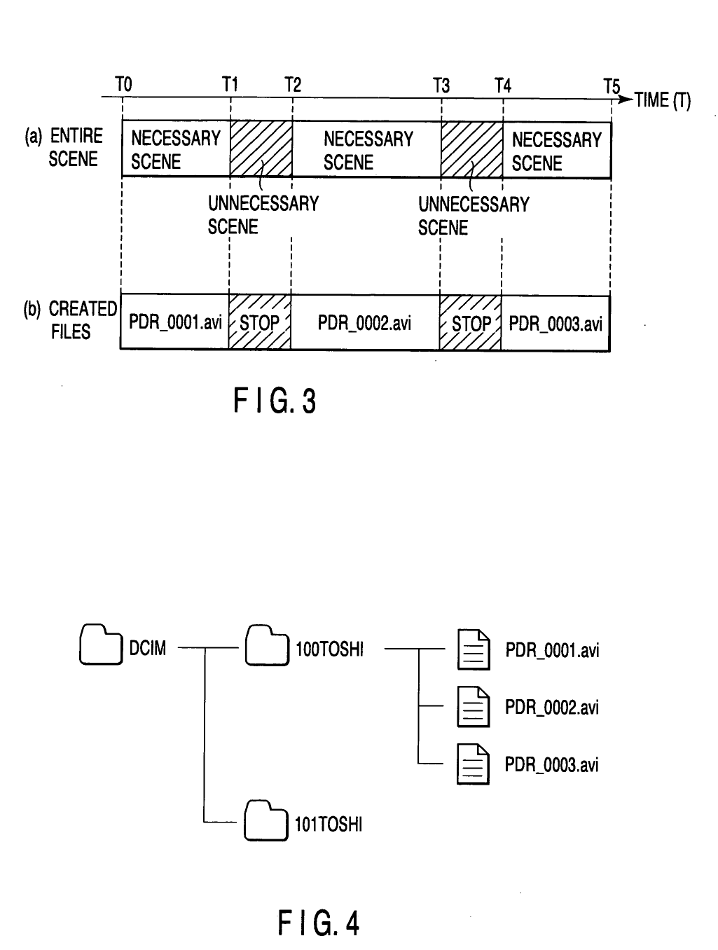

FIG. 3 shows an example of recording in the case where motion video is imaged with a prior-art digital still camera. In FIG. 3, portion (a) designates an entire scene in the case of taking motion video. Now assume that a time T0-T1 is associated with a necessary scene, a time T1-T2 with an unnecessary scene, a time T2-T3 with a necessary scene, a time T3-T4 with an unnecessary scene, and a time T4-T5 with a necessary scene.

In FIG. 3, portion (b) designates files that are created. In the prior art, the shutter button is pressed at time T0. Imaging of motion video is continued until time T1, and a file “PDR_{—}0001.avi” is created. From time T1 to time T2, an unnecessary scene intervenes, and imaging is stopped. At time T2, the shutter button is pressed once again and motion video is taken until time T3, and a file “PDR_{—}0002.avi” is created. From time T3 to time T4, an unnecessary scene intervenes, and imaging is stopped. At time T4, the shutter button is pressed and motion video is taken until time T5, and a file “PDR_{—}0003.avi” is created.

FIG. 4 shows an example of a configuration of files that are created by the above-described imaging of motion video. A folder DCIM includes a folder 100TOSHI. The folder 100TOSHI includes the three files (PDR_{—}0001.avi, PDR_{—}0002.avi and PDR_{—}0003.avi) shown in FIG. 3.

The three files, however, are independent from each other and unrelated. It is thus difficult to reproduce them successively.

In the present invention, a pause function is provided at a time of motion video imaging. If a pause is executed during motion video imaging, recording in the memory medium is temporarily stopped. If the pause is released, the imaging is resumed. Thereby, only necessary scenes can be imaged as a single file.

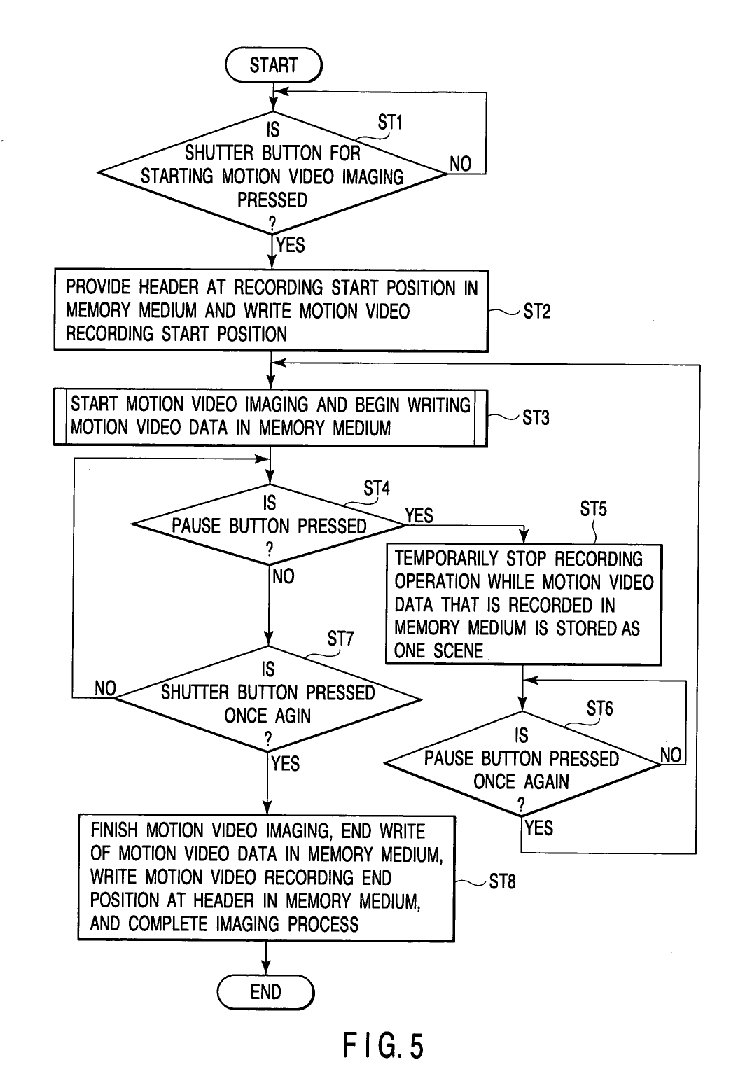

Referring now to a flow chart of FIG. 5, a description is given of the operation of motion video imaging in the digital still camera that has the structure shown in FIGS. 1 and 2.

When the shutter button 101 for starting the motion video imaging is pressed (ST1), the CPU 1 provides a header at a recording start position in the memory medium 20, thereby writing a motion video recording start position (ST2).

The CPU 1 starts motion video imaging, and begins writing motion video data in the memory medium 20 (ST3).

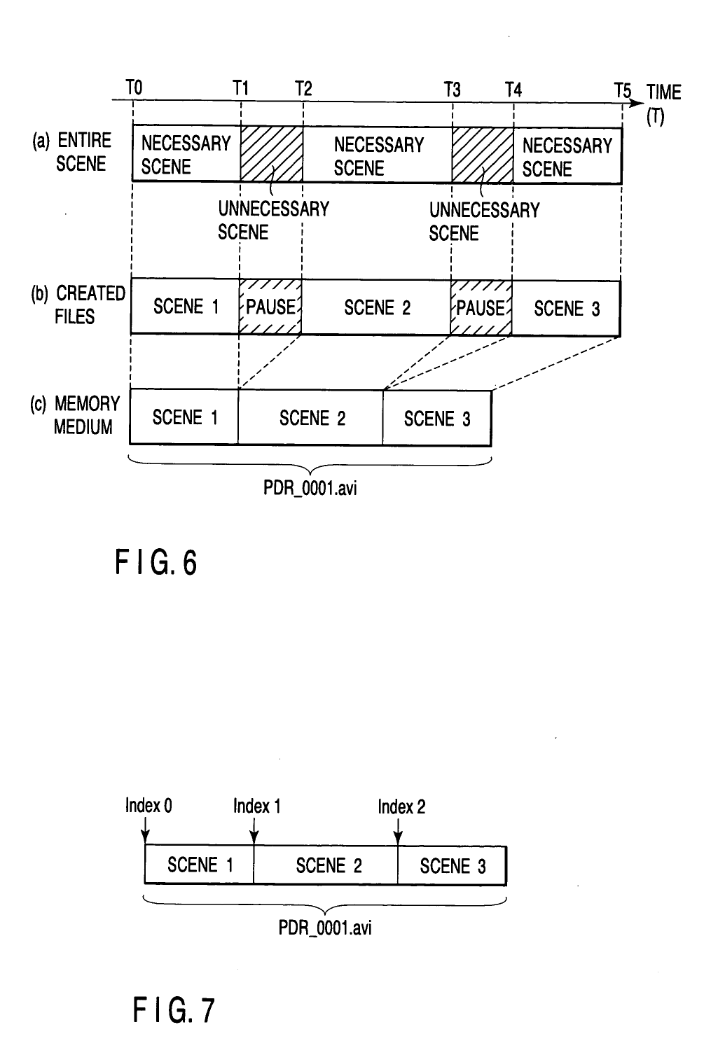

For example, as shown in FIG. 6, a necessary scene corresponding to time T0-T1 in an entire scene designated by portion (a) of FIG. 6 is imaged.

When an unnecessary scene (time T1) has come, the pause button 102 is pressed. When the pause button 102 is pressed (ST4), the CPU 1 temporarily stops the recording operation while motion video data that is recorded in the memory medium 20 is stored as a scene 1 (ST5).

When imaging is to be resumed (time T2), the pause button 102 is pressed once again. When the pause button 102 is pressed once again (ST6), the CPU 1 resumes the motion video imaging and begins writing motion video data in the memory medium 20 (ST3).

For example, as shown in FIG. 6, a necessary scene corresponding to time T2-T3 in the entire scene designated by portion (a) of FIG. 6 is imaged. In the memory medium that is designated by portion (c) in FIG. 6, motion video data on scene 2 is recorded following the scene 1.

When an unnecessary scene (time T3) has come, the pause button 102 is pressed. When the pause button 102 is pressed (ST4), the CPU 1 temporarily stops the recording operation while motion video data that is recorded in the memory medium 20 is stored as a scene 2 (ST5).

When imaging is to be resumed (time T4), the pause button 102 is pressed once again. When the pause button 102 is pressed once again (ST6), the CPU 1 resumes the motion video imaging and begins writing motion video data in the memory medium 20 (ST3).

For example, as shown in FIG. 6, a necessary scene beginning at time T4 in the entire scene designated by portion (a) of FIG. 6 is imaged. In the memory medium that is designated by portion (c) in FIG. 6, motion video data on scene 3 is recorded following the scene 2.

When the imaging is finished (time T5), the shutter button 101 is pressed once again. When the shutter button 101 is pressed once again (ST7), the CPU 1 finishes the motion video imaging and completes the write of motion video data in the memory medium 20. Further, the CPU 1 writes a motion video recording end position at the header in the memory medium 20 and creates a single file of the imaged motion video (ST8). Thus, the CPU 1 completes the process.

For example, as shown in FIG. 6, a necessary scene corresponding to time T4-T5 in the entire scene designated by portion (a) of FIG. 6 is imaged. In the memory medium that is designated by portion (c) in FIG. 6, the motion video data of scene 3 is recorded following the scene 2 and the motion video recording end position of the file is written. The scenes 1, 2 and 3 are recorded as a single file (PDR_{—}0001.avi) in the memory medium 20.

FIG. 7 shows an example of a file configuration to which indices are added when pauses are effected in the digital still camera according to the present invention. Specifically, when motion video imaging is started, an index (Index 0) is inserted (ST3). When the imaging is resumed after a pause, an index (Index 1, Index 2) is inserted in header information, etc. in the associated frame (ST3). At the time of reproduction, the indices are read such that a desired scene can be selected. Thus, reproduction can be executed from a desired one of the scenes.

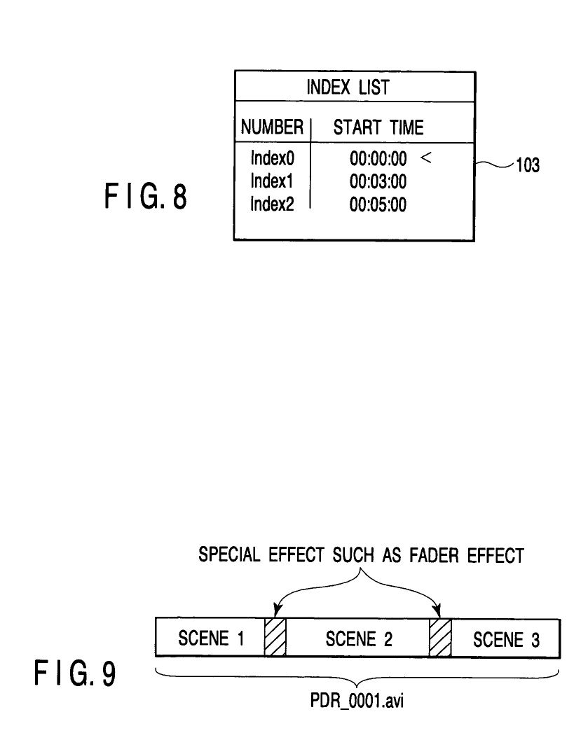

FIG. 8 shows an example of an index selection screen image, which is displayed on the color liquid crystal display section 103.

FIG. 9 shows an example of a file configuration to which a special effect, such as wipe or fader effect, is inserted at the timing of the pause in the digital still camera according to the invention. Thereby, unnatural connection between images before and after the pause is prevented, and it becomes easy to recognize where successive scenes begin.

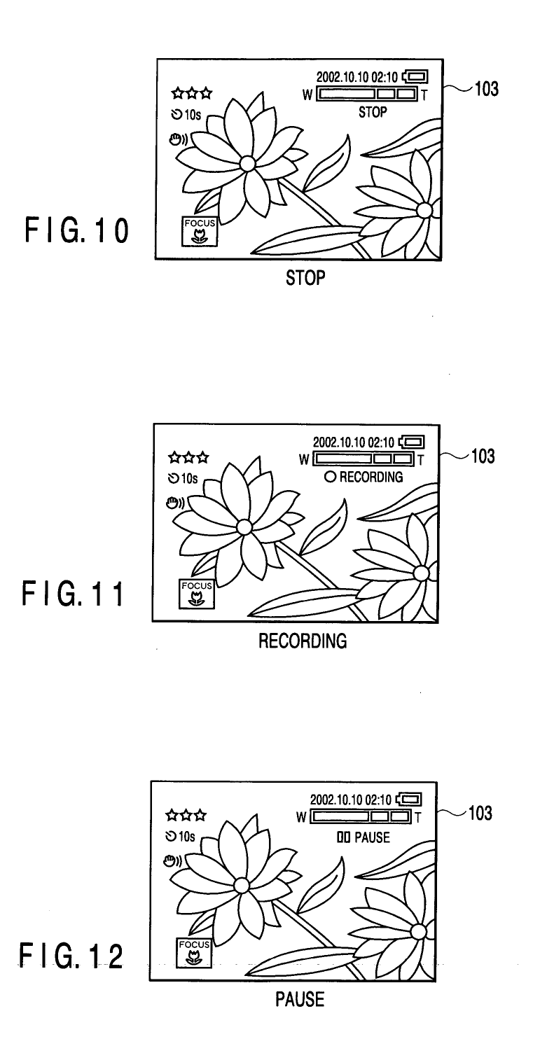

FIGS. 10, 11 and 12 show examples of screen displays on the color liquid crystal display section 103 of the digital still camera according to the invention. FIG. 10 shows a stop state, FIG. 11 shows a recording state, and FIG. 12 shows a pause state. These states are indicated by icons, characters, etc., and an erroneous operation can be prevented.

In the above-described embodiment, at the time of a pause, the recording of motion video data is simply stopped. Alternatively, a header part may be provided and a single file may be created each time a pause is effected. At the time of the end of the last motion video imaging operation, the created files may be put together into a single file.

In addition, if battery power outage or power-off occurs during the pause, the acquired motion video data may immediately be put together into a single file.

As has been described above, according to the embodiment of the present invention, only necessary parts in a long-time scene may be stored as a single file, and the usability can be enhanced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A digital still camera including imaging means for taking a still image and motion video, display means for displaying still image data and motion video data that is taken by the imaging means, and recording means for recording the still image data and motion video data that is taken by the imaging means, the digital still camera comprising:
pause instruction means for instructing a pause of imaging during the imaging of the motion video;
first control means for executing a control to effect a pause of the recording of the motion video data in the recording means when the pause of the imaging is instructed by the pause instruction means;
resume instruction means for instructing resumption of the recording of motion video data in the recording means, which is paused by the control of the first control means;
second control means for executing a control to resume the recording of motion video data in the recording means when the resumption of the recording is instructed by the resume instruction means;
stop instruction means for instructing a stop of the imaging of the motion video; and
third control means for executing, when the stop of the imaging of the motion video is instructed by the stop instruction means, a control to put together the motion video data recorded in the recording means, which includes motion video data taken before and after the pause, into a single file, and to store the single file in the recording means.

2. The digital still camera according to claim 1, wherein when the recording of the motion video data in the recording means is paused, one of the first control means and the second control means adds an index at a time of the pause or at a time of the resumption from the pause.

3. The digital still camera according to claim 1, wherein when the recording of the motion video data in the recording means is paused, one of the first control means and the second control means inserts special effects including wipe and fader effect into the motion video data taken before and after the pause.

4. The digital still camera according to claim 1, wherein the first control means executes a control to display on the display means an icon or the like that indicates that the imaging of the motion video is paused.
